(19) United States
(12) Patent Application Publication
(10) Pub. No.: US 2014/0068412 A1
(43) Pub. Date: Mar. 6, 2014

(54) Method and Apparatus of Responding to Webpage Access Request

(71) Applicant: Alibaba Group Holding Limited, Grand Cayman (KY)

(72) Inventor: Yan He, Hangzhou (CN)

(73) Assignee: Alibaba Group Holding Limited, Grand Cayman (KY)

(21) Appl. No.: 13/975,764

(22) Filed: Aug. 26, 2013

(30) Foreign Application Priority Data
Aug. 28, 2012 (CN) 201210311734.2

(51) Int. Cl. G06F 17/22

(52) U.S. Cl. CPC G06F 17/2247
USPC 715/234

(57) ABSTRACT

The present disclosure provides techniques to control webpage access. These techniques may receive, by a computing device, the request to visit a webpage. The computing device may then retrieve an identifier of the webpage and/or an identifier of the webpage element of the webpage. The computing device may also retrieve a corresponding resource requirement from a pre-configured resource allocation database based on the identifier of the webpage and/or the identifier of the webpage element. The computing device may then determine whether the resource requirement is larger than a current resource allocation. In response to the determination, the computing device may generate and return a webpage content based on a predetermined rule.

### CROSS REFERENCE TO RELATED PATENT APPLICATIONS

This application claims priority to Chinese Patent Application No. 201210311734.2, filed on Aug. 28, 2012, entitled “Method and Apparatus of Responding to Webpage Access Request,” which is hereby incorporated by reference in its entirety.

### TECHNICAL FIELD

The present disclosure relates to Internet technologies, and more specifically, to technologies for responding to requests for visiting webpage.

### BACKGROUND

A user visits a webpage to access various services provided by a website. For example, a user may visit a webpage for recharging mobile phone accounts. The webpage may include icons associated with a recharge link, a cash withdrawal service link, and/or a transaction link. When a user clicks the links, a visiting request for the webpage is generated and transmitted from a client terminal, i.e., a user computing device, to a server terminal, i.e., a server. Accordingly, the server may fetch a webpage content corresponding to the link and return the content to the client terminal.

Servers associated with a website may be under pressure and/or lose control if the website or any specific service of the website is under attack by hackers. For example, when servers constantly receive requests and the number of the requests is overwhelming, the servers may malfunction and even crash. As another example, when the attacks cause data loss, the website may lose business and suffer monetary damages.

A conventional solution is to turn off the servers. However, this causes a problem since the whole system (e.g., the servers) is shut down and other services unaffected by the attacks also are not available to ordinary users.

Therefore, there is a need to respond to requests for visiting a webpage when certain services associated with the webpage are not available due to, for example, hacker attacks on the certain services.

### SUMMARY

The present disclosure provides methods and/or systems for responding to a request for visiting a webpage when certain services associated with the webpage are not available due to, for example, hacker attacks.

To solve the above problem, the present disclosure provides a method for responding to a request for visiting a webpage. The method may include receiving, by a computing device, the visiting request that requests a visit to the webpage. The computing device may retrieve an identifier (ID) of the webpage and/or an ID of a webpage element of the webpage. The computing device may also retrieve a corresponding resource requirement from a pre-configured resource allocation database based on the ID of the webpage and/or the ID of the webpage element. The computing device may determine whether the resource requirement is larger than a current resource allocation. The computing device may generate and return a webpage content based on a predetermined rule when the resource requirement is larger than the current resource allocation.

In some embodiments, the resource requirement or the resource allocation may include at least one of a number of requests that are received in a predetermined time period, a network flow amount, an amount of input/output of a hard disk, an amount of traffic of a database, or an amount of CPU utilization associated with the computing device.

In some embodiments, the ID of a webpage is a Uniform Resource Locator (URL) address of the webpage. In these instances, the resource allocation database may be stored and include a correlation between the URL address of the webpage and the resource requirement. The computing device may retrieve the URL address in the visiting request.

In some embodiments, the resource allocation database may be stored and include a correlation between an attribute value of the webpage element and the resource requirement. In these instances, the computing device may retrieve a corresponding HyperText Markup Language (HTML) text based on the visiting request. Then, the computing device may sequentially parse each webpage element of the HTML text based on a sequence of Document Object Model (DOM) tree to obtain the corresponding attribute value of each webpage element.

In some embodiments, the computing device may compare the attribute value of each webpage element with the attribute value of the webpage element of the resource allocation database, and retrieve the resource requirement corresponding to the webpage element based on the comparison.

In some embodiments, the computing device may generate a HTML text indicating a prompt message of temporarily out of service, and return to a client terminal to display, or the computing device may generate a HTML text indicating a prompt message of waiting, and return to the client terminal to display.

In some embodiments, the computing device may set the attribute of the webpage element as “disabled” or “displayed” in the HTML text corresponding to the webpage or replace a display content of the webpage element with a prompt message of temporarily out of service. Then, the computing device may return the HTML text that is set or is replaced to a client for webpage display in response to a determination that the resource requirement of the webpage is larger than the current resource allocation.

In some embodiments, the computing device may further return a HTML text corresponding to the webpage being requested when the resource requirement is not larger than the current resource allocation. In some embodiments, the method may further set or modify the resource allocation.

In some embodiments, the present disclosure also provides a system for responding to a request for visiting a webpage. The system may include a receiving module, an ID module, a resource module, a determining module, and a first return module. The receiving module may be configured to receive a webpage visiting request. The ID module may be configured to retrieve a webpage ID and/or a webpage element ID of the webpage. The resource module may be configured to retrieve a corresponding amount of a resource requirement from a pre-configured resource allocation database based on the webpage ID and/or the webpage element ID. The determining module may be configured to determine whether the resource requirement is larger than a current resource allocation, and transfer the execution to a first return module if the resource requirement is larger than the current resource allocation. The first return module may be configured to generate a webpage content based on a predetermined rule.

The present disclosure may have one or more of the following advantages. In the present disclosure, after a visiting request for visiting a webpage is received, the corresponding resource requirement may be fetched from the pre-configured resource allocation database based on the URL or the webpage element ID of the webpage. If the current resource allocation cannot meet the resource requirement (e.g., the current server is unable to support the service corresponded to the webpage or the webpage element), a waiting webpage may be generated or returned to a prompt message that indicates the service is temporarily out of service. Thus, servers may not be overloaded and other server processes would not be affected when the webpage is under attack by hackers, therefore avoiding monetary damages on service providers.

This Summary is not intended to identify all key features or essential features of the claimed subject matter, nor is it intended to be used alone as an aid in determining the scope of the claimed subject matter.

### BRIEF DESCRIPTION OF THE DRAWINGS

The Detailed Description is described with reference to the accompanying figures. The use of the same reference numbers in different figures indicates similar or identical items.

FIG. 1 is a flow chart of an illustrating process for controlling webpage access.

FIG. 2 is another flow chart of an illustrating process for controlling webpage access.

FIGS. 3 and 4 are schematic diagrams of illustrative computing architectures that enable controlling webpage access.

### DETAILED DESCRIPTION

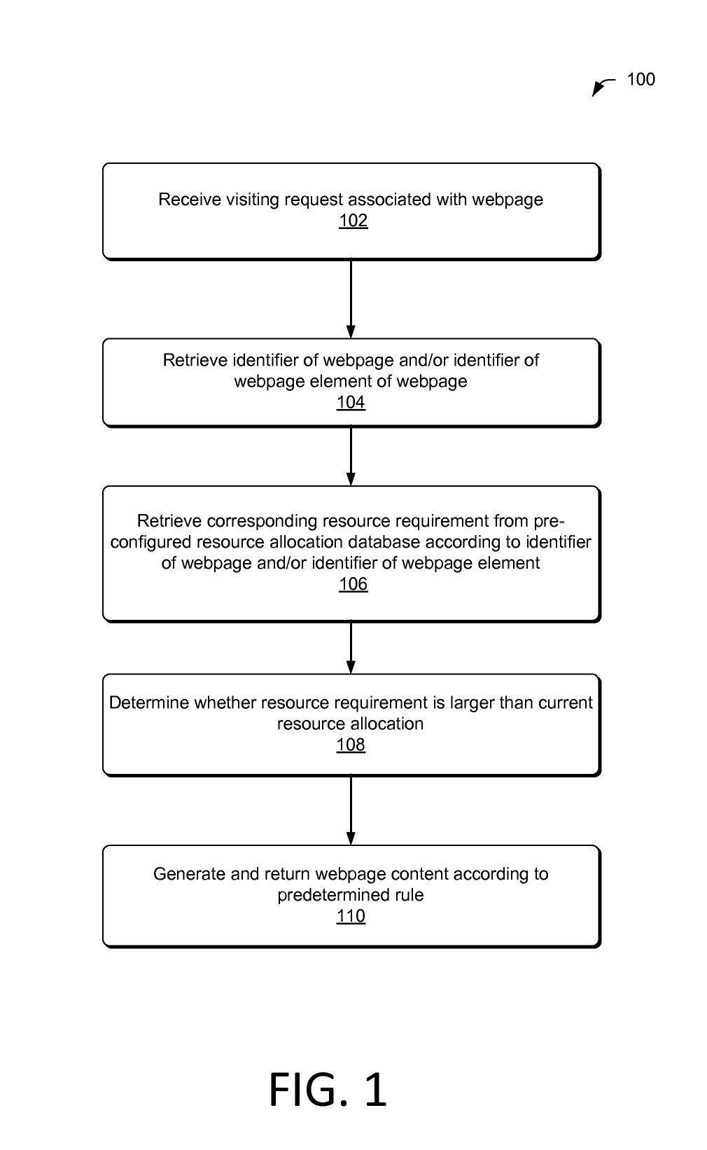

FIG. 1 is a flow chart of an illustrating process for controlling webpage access. The process 100 may be implemented by a computing device (e.g., a server) associated with a browser that is loaded with a webpage script to perform one or more operations. At 102, the computing device may receive the visiting request that requests a visit to the webpage. For example, a user inputs a URL address of a website service into an input field of address or clicks a link of the service in a webpage when the user intends to request a visit to the service of a website. Then, a browser generates a visiting request based on the click of the user or the URL address being inputted and sends the visiting request to a computing device.

At 104, the computing device may retrieve an identifier (ID) of the webpage and/or an ID of the webpage element of the webpage. The webpage being requested by the user may be a specific service of the website, and may contain several links to other webpage elements. Therefore, with respect to the webpage being requested by the user, the computing device may determine whether the webpage is to be displayed or not. The user cannot visit the service if the webpage is determined to be not displayed. Also, the computing device may also determine whether each webpage element contained in the webpage is to be displayed. In some embodiments, an ID of the webpage may be retrieved to determine whether the webpage is to be displayed. Alternatively, the ID of the webpage element may be retrieved to determine whether each webpage element is to be displayed. In some instances, the computing device may in advance determine whether the webpage is to be displayed. If determining to display, the computing device may further determine whether each webpage element of the webpage is to be displayed.

In some embodiments, the ID of the webpage is a Uniform Resource Locator (URL) address of the webpage. In these instances, the computing device may retrieve the URL address in the visiting request.

In some embodiments, the computing device may retrieve a corresponding HTML text based on the visiting request, and sequentially parse each webpage element of the HTML text based on a sequence of DOM tree to obtain the corresponding attribute value of each webpage element.

In some embodiments, the webpage ID may be the URL address of the webpage, which may be retrieved from the webpage. The webpage elements may include a variety of text, image, audio, animation, video, etc. contained in the webpage. The organizational form of the all webpage elements may be illustrated by example algorithm (1).

Algorithm (1)

```
<html>
<head>
</head>
<body>
      <input type=”submit” name=”xxxquerybutton_1”/>
      <a href=”xxx.alipay.com”name=”xxxservcie_1”/>
</body>
</html>
```

In some embodiments, each tag of <head> can be regarded as a webpage element. Each webpage element has a corresponding attribute value, respectively, for example, name, ID, type, etc. After the visiting request that requests a visit to the webpage is received, the computing device may retrieve the HTML text, and sequentially parse each webpage element based on a sequence of DOM tree to obtain the corresponding attribute value of each webpage element. In the above example, it is parsed to obtain the name of the webpage element as xxxquerybutton_{—}1, and the type of the webpage element is “submit”.

At 106, the computing device may retrieve a corresponding resource requirement from a pre-configured resource allocation database based on the ID of the webpage and/or the ID of the webpage element.

In some embodiments, the resource requirement may be obtained by selecting at least one of a number of requests that are received in a predetermined time period, a network flow amount, an amount of input/output of a hard disk, an amount of traffic of a database, or an amount of CPU utilization associated with the computing device.

In some embodiments, a correlation between the URL address of the webpage and the resource requirement is pre-configured in the resource allocation database. For example, there are 100 requests to the server within a per unit time for requesting the opening of A webpage. In some embodiments, a correlation between an attribute value of the webpage element and the resource requirement is pre-configured. For example, the requirement for current CPU utilization is less than 70% when opening a specific video is requested. This indicates that the resource requirement is 70%.

In some embodiments, the computing device may compare the attribute value of each webpage element with the attribute value of the webpage element of the resource allocation database, and retrieve the resource requirement corresponding to the webpage element based on the comparison.

In some embodiments, the attribute value of each webpage element may be retrieved. In a process of comparison associated with the resource allocation database, the computing device may compare the attribute value of each webpage element with the attribute value of the webpage element of the resource allocation database, thus retrieving the resource requirement corresponding to the webpage element based on the comparison.

At 108, the computing device may determine whether the resource requirement is larger than a current resource allocation, and then the operation advances to 110 if the resource requirement is larger than the current resource allocation.

The resource allocation and/or the resource requirement may include at least one of a number of requests that are received in a predetermined time period, a network flow amount, an amount of input/output of a hard disk, an amount of traffic of a database, or an amount of CPU utilization associated with the computing device. The resource allocation can be pre-configured or be obtained from a current resource status. For example, the current CPU utilization is 80%. If the resource requirement based on a certain webpage or a certain webpage element is larger than the current resource allocation, the current resource is unable to meet the requirement of the webpage or the webpage element. For example, in a recharge service for a mobile phone, the service may not be available if the CPU utilization is required as being less than 70% and the pre-configured resource allocation for the CPU utilization is 80%. For example, the service may not be available if the CPU utilization is required as being less than 70% and the current CPU utilization is detected as 80%.

At 110, the computing device may generate and return a webpage content based on a predetermined rule. In some embodiments, the webpage ID may include a URL address. In these instances, the computing device may generate a HTML text indicating a prompt message of temporary out of service, and return to a client terminal to display. In some instances, the computing device may generate a HTML text indicating a prompt message of waiting, and return to the client terminal to display.

In some embodiments, the computing device may generate the HTML text indicating the prompt message of temporarily out of service if the current webpage allocated resource is unable to meet the requirement of the resource allocation for visiting a specific webpage. The prompt message indicates that the webpage is temporarily out of service. In some instances, a browser may interpret it based on the HTML text and generate a webpage containing the prompt message. In some instances, the browser may generate a webpage containing a message of waiting, and cause a display of the message. The text may include a timer module configured to re-determine whether the current resource allocation is larger than the resource requirement of the webpage when the waiting time reaches a pre-determined value. If the current resource allocation is larger than the resource requirement of the webpage, the computing device may generate the HTML text corresponding to the webpage address.

In some embodiments, the ID of the webpage includes the ID of the webpage element. In some instances, the computing device may set the attribute of the webpage element as “disabled” or “displayed” with respect to the webpage element of which resource requirement is larger than the current resource allocation. In some instances, the computing device may cause a display of a prompt message of temporarily out of service.

In some embodiments, the computing device may return the HTML text that is set or is replaced to a client for webpage display.

While rendering a webpage, webpage elements of the webpage may not be displayed if the current web allocated resource is unable to meet the requirement of a resource allocation of the webpage elements. In some embodiments, the attribute of each webpage element may be set as “disabled” or “displayed.” In these instances, the attribute of the webpage element is set as “disabled” through the corresponding HTML text of the webpage to stop the display of the webpage element. In some embodiments, the attribute of the webpage element may be set as “disabled” or “unable” to not display the webpage element. In some embodiments, the different types of the webpage elements may be set by calling different handlers. For example, a handler corresponding to webpage element with class as div is document.getElementByld (“typediv1”), wherein style.visibility=“visible”. In determining whether a webpage element needs to be closed, a handler corresponding to the type of the webpage element may be further determined and used to close the webpage element. Then, the HTML text being processed may be sent to a browser for the interpretation, and the webpage element is not to be displayed in the webpage.

In some embodiments, a display content corresponding to the webpage element may be replaced by a prompt message. In these instances, the message, for example, informs a user that the service is temporarily out of service, and may be displayed in a corresponding position of the webpage element on the webpage.

With respect to a webpage visited by a user, the present disclosure determines whether the resource requirement of the webpage or of the webpage element is larger than the current resource allocation. If the resource requirement is not larger than the current resource allocation, the current resource may be unable to support the displaying process of the webpage or the webpage element. Then, the display may be terminated or a message may be returned to avoid the server being overloaded. Thus, this avoids affecting other visiting requests and other visits of the webpage service associated with a webpage when the webpage is under attack by hackers. Meanwhile, the present disclosure may also avoid monetary damages to the service providers.

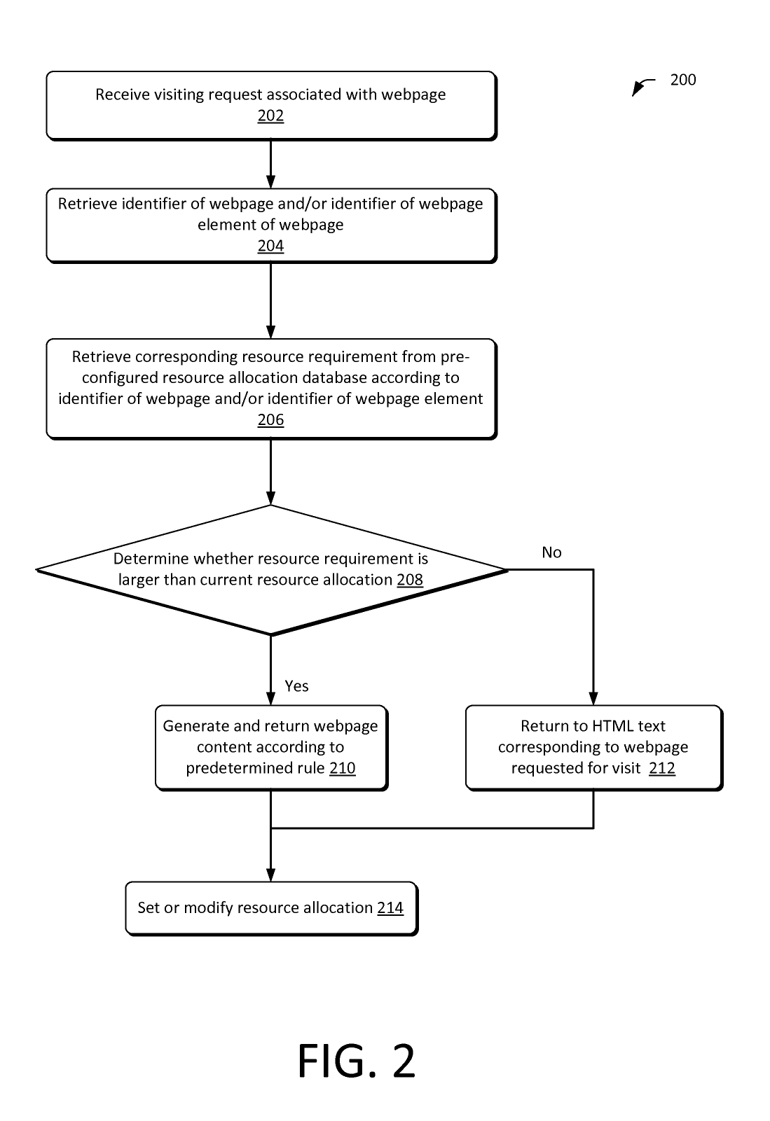

FIG. 2 is another flow chart of an illustrating process for controlling webpage access. The process 200 may be implemented by a computing device (e.g., a server) associated with a browser that is loaded a webpage script to perform one or more operations.

At 202, the computing device may receive the visiting request that requests a visit to the webpage.

At 204, the computing device may retrieve an ID of the webpage and/or an ID of the webpage element of the webpage.

At 206, the computing device may retrieve a corresponding resource requirement from a pre-configured resource allocation database based on the ID of the webpage and/or the ID of the webpage element.

At 208, the computing device may determine whether the resource requirement is larger than a current resource allocation. The process 200 may advance to operation 210 if the resource requirement is larger than the current resource allocation. The process 200 may advance 212 if the resource requirement is not larger than the current resource allocation.

At 210, the computing device may generate a webpage content based on a predetermined rule as a return of response.

At 212, the computing device may return to a HTML text corresponding to the webpage being requested for a visit.

In some embodiments, the webpage or the webpage element may be retrieved to be properly displayed if the resource requirement is able to satisfy the visiting request of the webpage or the webpage element. In these instances, the HTML text corresponding to the webpage may be retrieved based on the visiting request of the user and the process may be returned.

At 214, the computing device may set or modify the resource allocation. In some embodiments, the resource allocation may be pre-configured, and the amount of the resource allocation may be modified.

In some embodiments, a corresponding resource requirement from a pre-configured resource allocation database may be retrieved based on the ID of the webpage and/or the ID of the webpage element after the visiting request that requests a visit to the webpage is received. If the current resource allocation is not able to satisfy the resource requirement, the computing device cannot support the service of the webpage or the webpage element. Then, a waiting webpage may be generated to inform that the requested service is out of service. This may avoid the computing device being overloaded and prevent affecting other visiting requests associated with other services when the website hosting the webpage is under attack by hackers. Meanwhile, the present disclosure may also avoid monetary damages on service providers.

With respect to the embodiment of the method of the present invention, in order to simplify the description, it is explained as a combination of a series of operations. However, for people skilled in the art, it should be understood that the present invention is not limit to the order of the operations. Based on the present invention, some of the operations may be executed in other sequence or be simultaneously executed. Moreover, for people skilled in the art, it should be understood that the embodiments described in the specification are mere embodiments, the operations and the modules that is described are not all necessary for the present disclosure.

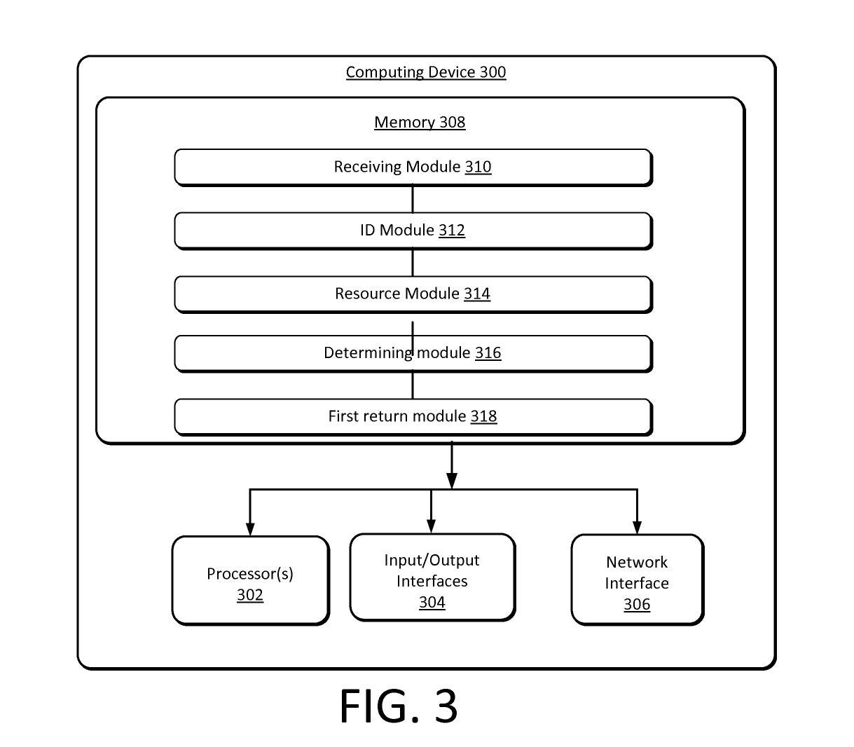

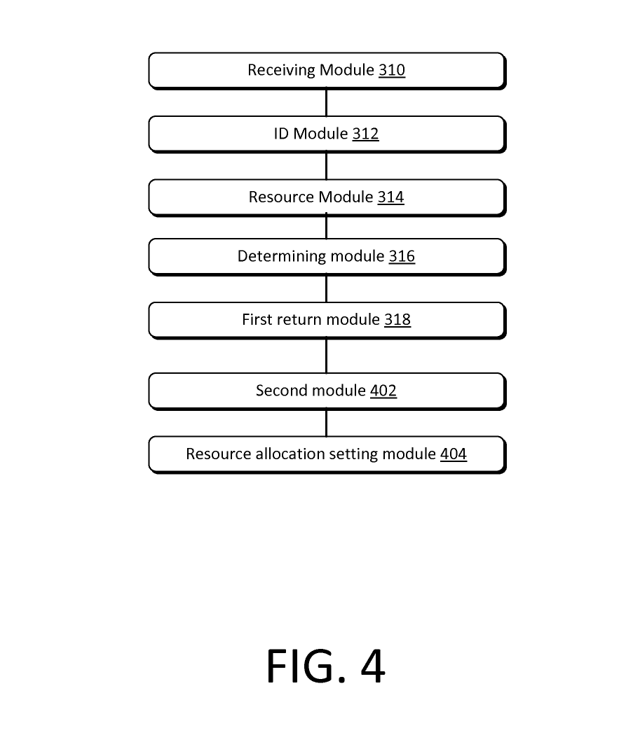

FIGS. 3 and 4 are schematic diagrams of illustrative computing architectures that enable controlling webpage access. FIG. 3 is a diagram of a computing device 300. In one exemplary configuration, the computing device 300 includes one or more processors 302, input/output interfaces 304, network interface 306, and memory 308.

The memory 308 may include computer-readable media in the form of volatile memory, such as random-access memory (RAM) and/or non-volatile memory, such as read only memory (ROM) or flash RAM. The memory 308 is an example of computer-readable media.

Computer-readable media includes volatile and non-volatile, removable and non-removable media implemented in any method or technology for storage of information such as computer readable instructions, data structures, program modules, or other data. Examples of computer storage media include, but are not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. As defined herein, computer-readable media does not include transitory media such as modulated data signals and carrier waves.

Turning to the memory 308 in more detail, the memory 308 may include a receiving module 310, an ID module 312, a resource module 314, a determining module 316, and a first return module 318. The receiving module 310 may be configured to receive a webpage visiting request. The ID module 312 may be configured to retrieve a webpage ID and/or a webpage element ID of the webpage. The resource module 314 may be configured to retrieve a corresponding amount of a resource requirement from a pre-configured resource allocation database based on the webpage ID and/or the webpage element ID. The determining module 316 may be configured to determine whether the resource requirement is larger than a current resource allocation. The first return module 318 may generate and return a webpage content if the resource requirement is larger than the current resource allocation.

In some embodiments, the resource requirement and/or the resource allocation may be obtained by selecting at least one of a number of requests that are received in a predetermined time period, a network flow amount, an amount of input/output of a hard disk, an amount of traffic of a database, or an amount of CPU utilization associated with the computing device.

In some embodiments, the ID of the webpage may be a URL address. The resource allocation database may include a correlation between the URL address and the resource requirement. In these instances, the ID module may include a sub-module configured to retrieve the webpage address URL from the visiting request.

In some embodiments, the resource allocation database includes the correlation between the attribute value of the webpage element and the resource requirement. In these instances, the ID module may a sub-module configured to retrieve the corresponding HTML text based on the visiting request, and another sub-module configure to sequentially parse each webpage element of the HTML text based on the sequence of DOM tree to obtain the corresponding attribute value of each webpage element.

In some embodiments, the resource module 314 may include a sub-module configured to compare the attribute value of each webpage element with the attribute value of the webpage element of the resource allocation database, and to retrieve the resource requirement corresponding to the webpage element in response to the comparison.

In some embodiments, the first return module may include a first sub-module configured to generate a HTML text included the prompt message of temporary out of service and returning to a client terminal to display, and/or a second sub-module configured to generate a HTML text corresponding to a waiting webpage and to return to the client terminal to display.

In some embodiments, the first return module may include a setting sub-module configured to set the attribute of the webpage element as “disabled” or “displayed” in the HTML text corresponding to the webpage or to replace a display content of the webpage element with a prompt message of temporarily out of service with respect to the webpage element of which resource requirement is larger than the current resource allocation. In some instances, the first return module may also include a third sub-module configured to return the HTML text that is set or replaced to a client terminal to display the webpage.

In some embodiments, the memory 308 may also include a second module 402 and a resource allocation setting module 404. The second return module 402 may be configured to return to a HTML text corresponding to the visiting request if the determining module determining that the determination result is “NO”. The resource allocation setting module 404 may be configured to set or modify the resource allocation.

Since the embodiments of the computing device 300 are similarly corresponding to the aforementioned embodiments of the method as illustrated in FIGS. 1 and 2, the related description for the embodiments of the apparatus may refer to the aforementioned description.

The present disclosure may be used in various kinds of general or specific environments or configurations for a computing system, such as a distributed computing environment including any one of a personal computer, a server computer, a hand-held device, a portable device, a tablet device, a multi-processor system, a system base on microprocessor, a set-top box, a programmable electronic consumer device, a network PC, a small computer, a mainframe computer.

The present disclosure can be implemented as a general text that is executable by a computer executing instruction, such as a program module. In some embodiments, a program module may include a routine, a program, an object, an element, and data structure that is for executing a specific task or implementing a specific abstract data type. The present disclosure can also be implemented in a distributed computing environment. In such distributed computing environment, a job is executed by a remote processing device that is connected through a communicating network. In the distributed computing environment, the program modules can be stored at local or remote computer storage media that includes a storage device.

As used herein, the terms “comprises,” “comprising,” or any other variations thereof are intended to cover a non-exclusive inclusion, so that a process, method, article, or system/apparatus that include a list of elements, and do not only include those elements but may include other elements not expressly listed or inherent to such process, method, article, or system/apparatus. An element proceeded by “comprises a . . . ”, “has a . . . ”, “includes a . . . ”, and “contains a . . . ” does not, without more constraints, preclude the existence of additional identical elements in the process, method, article, or apparatus that comprises, has, includes, and contains the element respectively.

The method for a webpage visit request and the responding system for a webpage visit request of present invention have been described in detail as above. This document has employed specific embodiments to explain the principles and implementation of the present invention. The above explanations are only meant to aid the comprehension of the methods and one or more core concepts of the present disclosure. Meanwhile, a person with general skill in the art would, on the basis of the concepts of the present invention, is able to make modifications to specific embodiments and to the scope of applications. Accordingly, the contents of this specification should not be understood as limiting the present invention.

What is claimed is:

1. A computer-implemented method for controlling webpage access, the method comprising:
receiving, by a computing device, a request for access to a webpage;
retrieving an identifier (ID) of the webpage;
determining an amount of an allocated resource corresponding to the ID of the webpage based on a pre-configured resource allocation database;
determining an amount of a requested resource associated with the request; and
in response to a determination whether the amount of the allocated resource is greater than the amount of the requested resource, generating and returning a webpage content based on a predetermined rule.

2. The computer-implemented method of claim 1, wherein the ID of the webpage comprises an ID of a webpage element of the webpage.

3. The computer-implemented method of claim 1, wherein the allocated resource comprises at least one of a number of requests that are received in a predetermined time period, a network flow amount, an amount of input/output of a hard disk, an amount of traffic of a database, or an amount of CPU utilization associated with the computing device.

4. The computer-implemented method of claim 1, wherein the ID of the webpage is a Uniform Resource Locator (URL) address of the webpage, the pre-configured resource allocation database includes a correlation between the URL address of the webpage and the requested resource.

5. The computer-implemented method of claim 4, wherein the retrieving the ID of the webpage comprises retrieving the URL address in the request.

6. The computer-implemented method of claim 1, wherein the pre-configured resource allocation database includes a correlation between attribute values of webpage elements of the webpage and attribute values of requested resources.

7. The computer-implemented method of claim 6, wherein the retrieving the ID of the webpage comprises:
retrieving a corresponding HyperText Markup Language (HTML) text based on the request; and
sequentially parsing individual webpage elements of the corresponding HTML text based on a sequence of Document Object Model (DOM) tree to obtain the attribute value of the webpage element.

8. The computer-implemented method of claim 6, wherein the determining the amount of the allocated resource corresponding to the ID of the webpage based on the pre-configured resource allocation database:
making a comparison between an attribute value of an webpage element of the webpage element with the attribute values of the requested resources; and
determining the amount of the allocated resource corresponding to an attribute value of the request resources based on the comparison.

9. The computer-implemented method of claim 6, wherein in response to the determination whether the amount of the allocated resource is greater than the amount of the requested resource, generating and returning a webpage content based on the predetermined rule comprises:
in response to a determination that the amount of the allocated resource is not greater than the amount of the requested resource, disabling an attribute of the webpage element of the webpage.

10. The computer-implemented method of claim 6, wherein in response to the determination whether the amount of the allocated resource is greater than the amount of the requested resource, generating and returning a webpage content based on the predetermined rule comprises:
in response to a determination that the amount of the allocated resource is greater than the amount of the requested resource, generating and causing a display of the webpage content.

11. The computer-implemented method of claim 1, further comprising:
setting or modifying the amount of the allocated resource.

12. A computing system for responding to a request for visiting a webpage, the system comprising:
one or more processors; and
memory to maintain a plurality of components executable by the one or more processors, the plurality of components comprising:
a receiving module configured to receive a request for access to a webpage,
an identifier (ID) module configured to retrieve an ID of the webpage,
a resource module configured to determine an amount of an allocated resource corresponding to the ID of the webpage based on a pre-configured resource allocation database,
a determining module configured to determine an amount of a requested resource associated with the request, and
a return module configured to, in response to a determination whether the amount of the allocated resource is greater than the amount of the requested resource, generate and return a webpage content based on a predetermined rule.

13. The system of claim 12, wherein the ID of the webpage comprises an ID of a webpage element of the webpage.

14. The system of claim 12, wherein the allocated resource comprises at least one of a number of requests that are received in a predetermined time period, a network flow amount, an amount of input/output of a hard disk, an amount of traffic of a database, or an amount of CPU utilization associated with the system.

15. The system of claim 12, wherein the ID of the webpage is a Uniform Resource Locator (URL) address of the webpage, the pre-configured resource allocation database includes a correlation between the URL address of the webpage and the requested resource.

16. One or more computer-readable media storing computer-executable instructions that, when executed by one or more processors, instruct the one or more processors to perform acts comprising:
receiving a request for access to a webpage;
retrieving an identifier (ID) of the webpage;
determining an amount of an allocated resource corresponding to the ID of the webpage based on a pre-configured resource allocation database;
determining an amount of a requested resource associated with the request; and
in response to a determination whether the amount of the allocated resource is greater than the amount of the requested resource, generating and returning a webpage content based on a predetermined rule.

17. The one or more computer-readable media of claim 16, wherein the pre-configured resource allocation database includes a correlation between attribute values of webpage elements of the webpage and attribute values of requested resources.

18. The one or more computer-readable media of claim 17, wherein the determining the amount of the allocated resource corresponding to the ID of the webpage based on the pre-configured resource allocation database:
making a comparison between an attribute value of a webpage element of the webpage element with the attribute values of the requested resources; and
determining the amount of the allocated resource corresponding to an attribute value of the request resources based on the comparison.

19. The one or more computer-readable media of claim 17, wherein in response to the determination whether the amount of the allocated resource is greater than the amount of the requested resource, generating and returning a webpage content based on the predetermined rule comprises:
in response to a determination that the amount of the allocated resource is not greater than the amount of the requested resource, disabling an attribute of the webpage element of the webpage.

20. The one or more computer-readable media of claim 17, wherein in response to the determination whether the amount of the allocated resource is greater than the amount of the requested resource, generating and returning a webpage content based on the predetermined rule comprises:
in response to a determination that the amount of the allocated resource is greater than the amount of the requested resource, generating and causing a display of the webpage content.
